(19) United States
(12) Patent Application Publication
(10) Pub. No.: US 2004/0014627 A1
(43) Pub. Date: Jan. 22, 2004

(54) Fabric conditioning compositions

(76) Inventors: Amanda Jane Adams, Merseyside (GB); Nigel Peter Bird, Merseyside (GB); David Machin, Merseyside (GB)

Correspondence Address: UNILEVER, PATENT DEPARTMENT, 45 RIVER ROAD, EDGEWATER, NJ, 07020, US

(21) Appl. No.: 10/399,337

(22) PCT Filed: Oct. 10, 2001
(86) PCT No.: PCT/EP01/11774

(30) Foreign Application Priority Data
Oct. 17, 2000 (GB) 0025442.5

(51) Int. Cl. C11D 3/00

(52) U.S. Cl. 510/329; 510/515

(57) ABSTRACT

An aqueous, liquid fabric conditioning composition and a method for making such a composition where the composition comprises a quaternary ammonium cationic softening compound, a perfume having a ClogP of 2 or more and an oily perfume carrier for the perfume, the carrier having a ClogP of 3.5 or more where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

### FIELD OF THE INVENTION

The present invention relates to fabric conditioning compositions, and in particular, relates to fabric conditioning compositions comprising emulsions having emulsion droplets with a mean diameter within a certain size range.

### BACKGROUND OF THE INVENTION

Rinse added fabric conditioning compositions are well known. Typically, such compositions comprise aqueous lamellar phase dispersions which have fabric softening properties.

One of the problems frequently associated with conventional fabric conditioning compositions is that perfume is lost upon storage of the product or is not delivered to fabric in sufficient quantities.

Delivery of insufficient perfume to fabrics is a problem particularly encountered with dilute fabric conditioning compositions, that is compositions containing less than 7.5% by weight of a quaternary ammonium softening material.

In order to overcome this, more perfume ingredient can be incorporated into the dilute composition. However, this leads to instability of the composition.

The problem of instability is especially noticeable when the product is stored at high temperatures.

Instability can manifest itself as a thickening of the product to the point where it is no longer pourable, flocculation of particles within the product or a lack of homogeneity exhibited by surface cracking of the product.

It is desirable, that in addition to softening, fabric conditioning compositions have stability upon storage at high temperature and good perfume characteristics such as longevity of fragrance and delivery of perfume to fabric to be treated.

WO 97/16516 describes a fabric softening composition comprising hydrophobic particles having a preferred mean diameter of from about 3 to about 15 microns in which the hydrophobic particles comprise perfume surrounded by a cationic softener and nonionic surfactant. A process for forming the composition is described and includes a homogenizing stage so as to provide dispersed small hydrophobic particles of perfume held in suspension by the surfactant activity of the cationic softener and nonionic surfactant. There is no disclosure of compositions comprising a perfume carrier where the carrier and the perfume have hydrophobicities selected for compatibility with each-other such that particles comprising the perfume partitioned into the perfume carrier are present.

U.S. Pat. No. 5,288,417 relates to a process for making an aqueous dispersion of a fabric softening composition and describes fabric conditioning active mean particle sizes of about 0.7 to 10 microns. It does not relate to emulsion-based compositions and has no disclosure or teaching of the use of perfumes in combination with perfume carriers having a hydrophobicity compatible with the perfume.

Co-pending application, GB 0021766.1, discloses a composition comprising a aqueous lamellar phase dispersion of fabric conditioning particles having a mean particle diameter of from 0.3 to 7 microns.

EP-B-0458599 discloses a fabric treatment composition comprising lamellar droplets of a fabric softening material in combination with an emulsion component. A deflocculating polymer having a hydrophilic backbone and one or more hydrophobic side chains is also present in the composition

EP-A-0746603 discloses a fabric softening composition comprising a quaternary ammonium softening compound and 0.1 to 10 wt % of a perfume/carrier substance mix having a slip point of less than 37° C.

Co-pending application PCT/EP00/04223, published as WO-A1-00/71806, discloses a cationic fabric softening agent and an emulsified silicone. The median droplet size of the silicone in the emulsion is 0.2 μm to 25 μm. Cationic and nonionic emulsifiers are disclosed.

Co-pending application GB9930436.2, published as WO-A1-01/46360, discloses compositions comprising an oily sugar stabiliser, a quaternary ammonium softening compound, a perfume and a nonionic surfactant. There is no reference to emulsions or particle sizes.

WO-A1-95/22594 discloses a fabric softening composition comprising a quaternary ammonium fabric softening agent and from 0.1 wt % to 10 wt % of a perfume/carrier substance mix having a slip point below 45° C. Although reference is made to the ester-linked quaternary ammonium compounds being present in an amount of at least 1% by weight of the composition, especially interesting are said to be concentrated compositions which comprise between 10 and 30% by weight of ester-linked quaternary ammonium compound. Furthermore, all of the examples relate to highly concentrated compositions containing 14.5 wt % or even 20 wt % of the ester-linked quaternary ammonium compound. There is no enabling disclosure of improving stability and perfume delivery at low concentrations of the quaternary ammonium material. In addition, the only perfume carriers disclosed in the examples are tallow oil and palm oil. There is no disclosure of either mineral oils or the combination of ester oils with a fatty alcohol.

### OBJECTS OF THE INVENTION

The present invention seeks to address one or more of the above-mentioned problems, and, to give one or more of the above-mentioned benefits desired by consumers.

Surprisingly, we have found that a fabric conditioning composition comprising an aqueous emulsion formed from hydrophobic ingredients where the emulsion has droplets within a certain size range exhibit good physical stability upon storage at high temperature, and excellent perfume characteristics.

### SUMMARY OF THE INVENTION

According to the present invention there is provided:

an aqueous, liquid fabric conditioning composition comprising:

(i) from 2.1 to 7% of a quaternary ammonium cationic softening compound; and

(ii) a perfume having a ClogP of 2 or more; and

(iii) an oily perfume carrier having a ClogP of 3.5 or more;

where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

The invention further provides:

an aqueous, liquid fabric conditioning composition comprising:

(i) a quaternary ammonium cationic softening compound; and

(ii) a perfume having a ClogP of 2 or more; and

(iii) an oily perfume carrier comprising a mineral oil having a ClogP of 3.5 or more;

where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

The invention additionally provides:

an aqueous, liquid fabric conditioning composition comprising:

(i) a quaternary ammonium cationic softening compound; and

(ii) a perfume having a ClogP of 2 or more; and

(iii) an oily perfume carrier comprising an ester oil having a ClogP of 3.5 or more; and

(iv) a fatty alcohol

where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

In the context of the present invention, the term “comprising” embraces “consisting of” and “including but not limited to”. Thus, the ingredients or steps following the term “comprising” are not exhaustive.

### DETAILED DESCRIPTION OF THE INVENTION

The present invention is concerned with aqueous fabric conditioning compositions which comprise emulsions.

In the context of the present invention, the term ‘emulsion’ means a liquid product which, at ambient temperature, is opaque, metastable, comprises droplets, or groups of droplets, of one immiscible liquid suspended in another liquid and which shows none of the signatures of a lamellar phase dispersion as evaluated by low angle x-ray diffraction and polarising light microscopy.

The term emulsion does not include conventional micro-emulsions which are clear and isotropic and which are thermodynamically stable across a specified temperature range.

Furthermore, it does not include conventional fabric conditioning compositions which consist entirely of aqueous lamellar phase dispersions. Aqueous lamellar phase dispersions consist of a suspension of a lamellar liquid crystalline phase in a liquid, in which the molecular packing of the suspended material results in a structure which exhibits long range order.

The compositions of the present invention may comprise a mixture of emulsion droplets and dispersions. These compositions are entirely different from conventional aqueous lamellar dispersions which are free of an emulsion component. For instance, unlike pure dispersions, mixed emulsion/dispersion compositions do not necessarily exhibit long range order.

In the context of the present invention, “long range order” means positional and orientational order of the structure in at least one direction. For an explanation of positional and orientational order, see “Introduction to Liquid Crystals”, Chemistry and Physics, P. J. Collings and M Hird, printed 1997, reprinted 1998, p1.

Long range order can be verified by detection of Bragg peaks using low angle x-ray diffraction or by observing the composition in a polarising light microscope.

In the present invention, it is believed that the hydrophobic perfume partitions into the oily perfume carrier and thus forms perfume carrier/perfume emulsion droplets. Without being bound by theory, it is believed that this is because in a mixed emulsion/dispersion system, it will be thermodynamically preferable for the specified hydrophobic perfume components to partition into the hydrophobic oily perfume carrier (forming emulsion droplets of perfume carrier/perfume) rather than into the dispersion phase.

In the rinse cycle of a wash, co-deposition of the mixture of the perfume carrier and perfume improves the efficiency of perfume delivery to and perfume retention on the fabric being treated.

Therefore, the fabric conditioning compositions of the present invention comprising an emulsion or a mixture of emulsion and dispersion components (rather than a pure dispersion) are highly desirable because the emulsion (component) provides benefits, particularly perfume delivery benefits and good lubrication of fabric treated with the composition.

Emulsion Droplet Sizes

In the composition, 80% or more by weight of the droplets in the emulsion have a mean diameter of from 0.4 to 60 microns, as measured using a Malvern particle size analyser, according to the method below. More preferably, 80% or more by weight of the droplets have a mean diameter of from 0.5 to 50 microns, most preferably from 0.6 to 35 microns, e.g. 0.6 to 30 microns, or even 0.6 to 25 microns.

Without wishing to be bound by theory, it is believed that the droplets, 80% or more by weight of which have a diameter of from 0.4 to 60 microns, as measured using a Malvern particle size analyser, are agglomerations of minute particles of the oily perfume carrier and perfume which comprise both individual oily emulsion particles/droplets and droplets which consist of flocs of flocculated oily emulsion particles/droplets.

Thus, in the context of the present invention, the term ‘droplet’ includes both individual oily emulsion particle/droplets as well as flocs of flocculated oily emulsion particles/droplets.

The nature of the emulsion droplets being measured will, of course, be apparent to the person skilled in the art using a Malvern particle size analyser and following the method of measuring droplet size, as set out below and correlating to measured droplet sizes with observations using a phase-contrast light microscope.

Method of Measuring Droplet Size

The emulsion droplet size is measured using a Malvern particle size analyser using a 45 mm lens for D[0,1] measurements and both a 45 mm and a 1000 mm lens for D[0,9] measurements. D[0,1] and D[0,9] readings denote droplet sizes which 10% by weight and 90% by weight respectively of the droplets are below.

The particle size analyser is a Malvern Mastersizer X.

A presentation code of 2LAD is used to reflect the average refractive index difference between oily droplets and water and between dispersed cationic softening compound lamellar phase particles and water.

Without wishing to be bound by theory, it is believed that the results obtained will be dependent at least partly on the lens selected since each lens will have maxima and minima measurement range and thus if particles outside of this range are present they may not be measured. Therefore, to ensure that the droplet mean diameter is within the mean diameter range of the invention, as measured using a 45 mm lens, it must be ensured that the emulsion does not comprise flocs of flocculated particles above the measurement capabilities of a 45 mm lens. Accordingly, a 1000 mm lens is used to confirm the D[0,9] measurement, using the 45 mm lens, so as to ensure that no large flocs (not registered using the 45 mm lens) are present in the emulsion.

ClogP Measurements

The hydrophobicity of the perfume and oily perfume carrier are measured by ClogP. ClogP is calculated using the “ClogP” program (calculation of hydrophobicities as logP (oil/water)) version 4.01, available from Daylight Chemical Information Systems Inc of Irvine Calif., USA.

Quaternary Ammonium Cationic Fabric Softening Compound

The fabric conditioning composition of the present invention comprises one or more quaternary ammonium cationic fabric softening compounds.

It is preferred that the fabric softening compound(s) used is/are selected from those which are typically included in rinse-added fabric softening compositions.

The quaternary ammonium fabric softening compounds may have at least one ester group.

The cationic softening compounds may comprise quaternary ammonium compounds having two C₈-C₂₈ alkyl or alkenyl chains being directly attached to the nitrogen of the quaternary ammonium group. As a suitable source for the hydrocarbyl chains, fatty compounds based on tallow and/or palm chains are particularly preferred although fatty compounds based on other sources for the hydrocarbyl chain, especially vegetable sources, are also suitable.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

An especially preferred type of cationic softening compound is a quaternary ammonium material which comprises a compound having two C₁₂₋₁₈ alkyl or alkenyl groups connected to the nitrogen head group via at least one ester link. It is more preferred if the quaternary ammonium material has two ester links present.

A first group of preferred ester-linked cationic softening compounds for use in the invention is represented by formula (I):

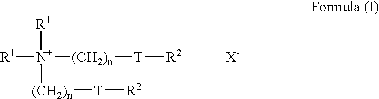

wherein each R¹ group is independently selected from C₁₋₄ alkyl or hydroxyalkyl or C2-4 alkenyl groups; and wherein each R² group is independently selected from C₈₋₂₈ alkyl or alkenyl groups;

T is

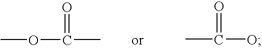

X⁻ is any anion compatible with the cationic surfactant, such as halides or alkyl sulphates, e.g. chloride, methyl sulphate or ethyl sulphate and n is 0 or an integer from 1 to 5.

Especially preferred materials within this formula are di-alkenyl esters of triethanol ammonium methyl sulphate and N-N-di(tallowoyloxy ethyl) N,N-dimethyl ammonium chloride. Commercial examples of compounds within this formula are Tetranyl (trade name) AOT-1 (di-oleic ester of triethanol ammonium methyl sulphate 80% active), AHT-1 (di-hardened tallowyl ester of triethanol ammonium methyl sulphate 80% active), AO-1(di-oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex Goldschmidt Corporation.

A second preferred type of quaternary ammonium material is represented by formula (II):

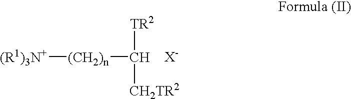

wherein R¹, R², n, T and X⁻are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third preferred type of quaternary ammonium material is represented by formula (III):

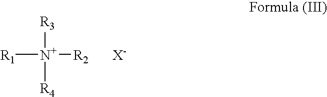

where R₁ and R₂ are C₈₋₂₈ alkyl or alkenyl groups; R₃ and R₄ are C₁₋₄ alkyl or C₂₋₄ alkenyl groups and x⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride, di(hardened palm) dimethyl ammonium chloride and di(coconut alkyl) dimethyl ammonium chloride.

The cationic softening compounds are preferably present in an amount from 1.5 to 60% by weight of cationic surfactant (active ingredient) based on the total weight of the composition, more preferably 1.7 to 45% by weight, most preferably 2 to 10% by weight, e.g. 2.1 to 7% by weight, or even 2.2 to 6% by weight.

The present invention is found to be particularly beneficial to perfume delivery and stability of compositions comprising 7% by weight or less of the fabric softening compound.

The cationic softening compound may be substantially water insoluble. ‘Substantially water insoluble’ compounds in the context of this invention are defined as compounds having a solubility less than 1×10⁻³ wt % in demineralised water at 20° C. Preferably the cationic softening compounds have a solubility less than 1×10⁻⁴ wt %. Most preferably the cationic softening compounds have a solubility at 20° C. in demineralised water from 1×10⁻⁶ to 1×10⁻⁸ wt %.

Perfume Carrier

The perfume carrier is an oily substance having a ClogP of 3.5 or more, more preferably 6 or more, most preferably 8 or more. Especially preferred are water insoluble oils having a ClogP of 10 or more.

Any oily compound having a hydrophobicity, as defined by ClogP values, and which is thus compatible with the perfume is suitable for use as the carrier in the compositions of the present invention. By “compatible” is meant that the perfume carrier and the perfume form a liquid mixture (of emulsion droplets) at ambient temperature.

Preferably the perfume carrier has a slip point below 45° C., more preferably below 37° C. The slip point of a material is measured according to the definition as set out in British Standard BS684 section 1.3 1991 ISO 6321:1991 (UK).

Suitable oily perfume carrier materials include mineral/hydrocarbon oils, ester oils, sugar ester oils and/or natural oils such as vegetable oils. However, ester oils or mineral oils are preferred. If the oil is an ester oil, it is especially preferred that the composition also comprises a fatty alcohol, such as hardened tallow alcohol in order to aid stabilisation of the composition.

Mineral oils are most preferred. Ideally, the mineral oil comprises a hydrocarbon oil containing substantially only carbon and hydrogen. The hydrocarbon oils are preferably substantially free of aromatic components and are fully saturated. Suitable hydrocarbon oils can comprise a mixture of different chain length hydrocarbons, e.g. from C₈ to C₄₀, having various degrees of branching. The hydrocarbon oils are preferably aliphatic.

In the present invention, it has been found that excellent stability and perfume delivery can be achieved when the perfume carrier comprises either a mineral oil or comprises an ester oil together with a fatty alcohol as an additional stabilising agent.

According to the present invention, the oily perfume carrier material is not a silicone oil and is preferably not a fluorocarbon oil.

The ester oils are hydrophobic in nature. They include fatty esters of mono or polyhydric alcohols having from 1 to 24 carbon atoms in the hydrocarbon chain, and mono or polycarboxylic acids having from 1 to 24 carbon atoms in the hydrocarbon chain, provided that the total number of carbon atoms in the ester oil is equal to or greater than 16, and that at least one of the hydrocarbon chains has 12 or more carbon atoms.

Suitable ester oils include substantially saturated ester oils (i.e. having less than 10% by number of unsaturated carbon-carbon bonds), such as the PRIOLUBES (ex. Unichema). 2-ethyl hexyl stearate (PRIOLUBE 1545), neopentyl glycol monomerate (PRIOLUBE 2045) and methyl laurate (PRIOLUBE 1415) are particularly preferred although oleic monoglyceride (PRIOLUBE 1407) and neopentyl glycol dioleate (PRIOLUBE 1446) are also suitable.

Other suitable esters oils include fatty acid glyceride esters as defined in EP-A1-0746603, e.g. palm oil and tallow oil.

Suitable oily sugar ester compounds include the sugar ester oils defined in WO-A-98/16538, which are hereby incorporated by reference. The oily sugar esters preferably have a viscosity of from 5 to 50 Pa.s, and preferably have a density of from 0.8 to 1.2 gcm⁻³, more preferably from 0.9 to 1 gcm⁻³, most preferably from 0.93 to 0.99 gcm⁻³.

It is preferred that the viscosity of the ester oil is from 0.002 to 2.0 Pa.S, more preferably from 0.004 to 0.4 Pa.s at a temperature of 25° C. at 106s⁻¹, measured using a Haake rotoviscometer RV20 NV cup and bob, and that the density of the mineral oil is from 0.8 to 0.9 g.cm⁻³ at 25° C.

Suitable mineral oils include branched or straight chain hydrocarbons (e.g. paraffins) having 8 to 35, more preferably 9 to 20 carbon atoms in the hydrocarbon chain.

Preferred mineral oils include the Marcol technical range of oils (ex Esso) although particularly preferred are the Sirius range (ex Fuchs), the Semtol range (ex Goldschmidt), or the Merkur Tec range (ex Merkur Vaseline).

The molecular weight of the mineral oil is typically within the range 100 to 400.

One or more oils of any of the above mentioned types may be used, although it is particularly preferred that the oil has substantially no surface activity.

It is believed that the oil provides excellent perfume delivery to the cloth and also increases perfume longevity upon storage of the composition.

The oil may be present in an amount from 0.1 to 15% by weight, more preferably 0.25 to 14%, by weight most preferably 1 to 10%, e.g. 2 to 9% by weight based on the total weight of the composition.

Perfume

The compositions of the invention comprise one or more perfumes.

The perfume has a ClogP of 2 or more, more preferably 2.2 or more, even more preferably 2.5 or more, most preferably 3 or more, e.g. 10 or more.

Suitable perfume ingredients having a ClogP of 2 include but are not limited to those disclosed in U.S. Pat. No. 5,500,137.

The perfume is preferably present in an amount from 0.01 to 10% by weight, more preferably 0.05 to 5% by weight, most preferably 0.07 to 2.5% by weight, based on the total weight of the composition.

For good perfume delivery to the fabric, it is desirable that the weight ratio of perfume to oily perfume carrier is from 1:50 to 2:1, more preferably 1:40 to 1:1, most preferably 1:20 to 1:2.

The perfume/perfume carrier emulsion droplets are preferably present at a level of 0.5 to 15% by weight, more preferably 1 to 10% by weight, most preferably 1.5 to 8% by weight, e.g. 1.8 to 6% by weight, based on the total weight of the composition.

It is preferred that the weight ratio of the perfume/perfume carrier emulsion droplets to quaternary ammonium fabric softening compound is from 5:1 to 1:25, more preferably 4:1 to 1:15, most preferably 3:1 to 1:6.

Water

The compositions of the invention are aqueous based.

Typically, the level of water present is from 50-98% by weight, more preferably 60-97% by weight, most preferably 70-96% by weight, e.g. 80-95% by weight, based on the total weight of the composition.

Co-active Softening Surfactants

Co-active softening surfactants for the cationic surfactant may also be incorporated in an amount from 0.01 to 20% by weight, more preferably 0.05 to 10%, based on the total weight of the composition. Preferred co-active softening surfactants are fatty acids, fatty esters, fatty amines and fatty N-oxides.

Preferred fatty acids include hardened tallow fatty acid, which may be present in an amount of from 0.1 to 20 wt %, based on the total weight of the composition.

Preferred fatty esters include compounds having a fatty monoester component, such as glycerol monostearate (GMS). If GMS is present, then it is preferred that the level of GMS in the composition is from 0.01 to 10 wt %, based on the total weight of the composition.

It is particularly preferred that GMS is present in the compositions since it is believed that compositions comprising GMS have additional thickening, stabilising and softening benefits. However, for the purposes of the present invention, GMS is not an essential ingredient of the compositions of the invention.

Polymeric Thickeners

It is useful, though not essential, if the compositions comprise one or more polymeric thickeners. Suitable polymeric thickeners include nonionic and cationic polymers, such as hydrophobically modified cellulose ethers (e.g. Natrosol Plus, ex Hercules) or cationically modified starches (e.g. Softgel BDA and Softgel BD, both ex Avebe). Nonionic and/or cationic polymers are preferably present in an amount of 0.01 to 5 wt %, more preferably 0.02 to 4 wt %, based on the total weight of the composition.

The compositions of the invention are preferably free of polymers which are anionic or have an anionic nature (i.e. polymers which react in a way typical of anionic polymers).

Other Optional Ingredients

The compositions may also contain one or more optional ingredients conventionally included in fabric conditioning compositions such as pH buffering agents, fluorescers, colourants, hydrotropes, antifoaming agents, skin benefit agents, menthols, antiredeposition agents, polyelectrolytes, enzymes, optical brightening agents, anti-shrinking agents, anti-wrinkle agents, anti-spotting agents, germicides, insecticides, insect repellants, fungicides, antioxidants, sunscreens, anti-corrosion agents, drape imparting agents, anti-static agents, ironing aids and dyes.

Product Form

In its undiluted state at ambient temperature the product comprises a liquid emulsion or a mixture of an emulsion and a dispersion. Preferably the product comprises an emulsion of oily droplets alone or in combination with an aqueous cationic lamellar dispersion.

It is preferred that the product is free of solid particles.

Product Use

The composition is preferably used in the rinse cycle of a home textile laundering operation, where, it may be added directly in an undiluted state to the washing machine, e.g. through a dispenser drawer. Alternatively, it can be diluted prior to use. The compositions may also be used in a domestic hand-washing laundry operation.

Preparation

The compositions of the invention may be prepared according to any suitable method.

In a first preferred method, the quaternary ammonium cationic softening compound, perfume carrier and optional co-actives, such as fatty acid, fatty alcohol and glycerol monostearate, are mixed in a premix vessel and heated to at least 5° C. above either the phase transition temperature of the softening compound or the melting point of the optional co-active so as to form a homogeneous premixture. Water is heated to between 35° C. and 70° C. in a separate vessel and is optionally blended with a pH buffering agent (e.g. phosphoric acid or citric acid).

The premixture is then mixed with the water and milled with 2 batches or more per hour, more preferably 3 batches or more, passing through the mill. That is, preferably at least 86%, more preferably at least 95% of the batch passes through the mill at least once.

Alternatively, the premixture may be injected into the water in a recycle loop prior to passing through the mill, in which case 100% of the batch passes through the mill at least once.

The milled mixture is cooled to at least 5° C. below the phase transition temperature of the resulting mixture with optional further milling.

Perfume and optional ingredients such as dye are then added (with milling/mixing, if necessary, to achieve a homogeneous composition).

### EXAMPLES

The invention will now be illustrated by the following non-limiting examples. Further modification within the scope of the present invention will be apparent to the person skilled in the art.

Examples of the invention are represented by a number. Comparative examples are represented by a letter.

### Examples 1 to 10 and A to F

Evaluation of Perfume Delivery on Cloth

The compositions of examples 1 to 7 and A to F were prepared according to the first preferred method described above, except that, for examples A to F, when milling the premix with the water, less than 2 batch volumes of the mixture passed through the mill. The degree of milling of the compositions is shown in table 2.

Examples 8 to 10 were prepared on a 200 ml scale. The quaternary ammonium compound, perfume carrier, fatty acid, and tallow alcohol were co-melted. Water was heated to 55° C. and the co-melt was added to the water over a period of 1 minute with stirring using a Heidolph RZR 50 mixer on a medium setting. The mixture was stirred for a further 10 minutes. The mixture was then allowed to cool to 40° C. and minor ingredients and perfume were added. The mixture was stirred for a further 5 minutes whilst cooling to room temperature.

TABLE 1

| | % by weight of active ingredient | |
|---|---|---|
| Component | Examples 1-7 and A-F | Examples 8-10 |
| DHTDMAC¹ | 2.20 | 2.20 |
| Fatty acid² | 0.38 | 0.37 |
| Perfume carrier³ | 3.30 | 3.30 |
| GMS⁴ | 0.10 | 0.10 |
| Perfume⁵ | 0.30 | 0.30 |
| Tallow Alcohol⁶ | 0.75 | |
| Minor ingredients⁷ | 0.11 | 0.04 |
| Water | To 100 | To 100 |

¹dihardened tallow dimethyl ammonium chloride (ex Akzo)
²hardened tallow fatty acid (Pristerene 4981 ex Uniqema)
³Examples 1 to 7 and A to F: Serntol 70/28 (ex Goldschmidt) An animal feed grade hydrocarbon oil with a ClogP greater than 12.
Example 8: corn oil (ex Sigma Aldrich Company)
Example 9: cotton seed oil (ex Sigma Aldrich Company)
Example 10: sunflower seed oil (ex Sigma Aldrich Company)
⁴glycerol monostearate (ex Cognis)
⁵Soft Touch MOD 178 (ex Givaudan Roure) with a ClogP greater than 2.
⁶Laurex CS (ex Albright & Wilson).
⁷orthophosphoric acid, dye and, for examples 1 to 7 and A to F only, formaldehyde

TABLE 2

| | | % Fraction of | |
|---|---|---|---|
| | Batch | batch milled | |
| | volumes | with Dispax | |
| | passed | DR3/5 reactor or | Water |
| | through | Silverson | temperature |
| Example | mill | 150/250 MS | (° C.) |
| 1 | 3.3 | 96 | 50 |
| 2 | 3.3 | 96 | 50 |
| 3 | 4.6 | 99 | 50 |
| 4 | 3.3 | 96 | 50 |
| 5 | 5.0 | 99 | 45 |
| 6 | 3.2 | 96 | 45 |
| 7 | 4.6 | 99 | 50 |
| A | 1.6 | 80 | 45 |
| B | 1.0 | 63 | 50 |
| C | 1.9 | 85 | 55 |
| D | 0.8 | 55 | 40 |
| E | 1.9 | 85 | 55 |
| F | 1.0 | 63 | 50 |

Compositions were tested for their ability to deliver to cloth.

In examples 1 to 5 and A to C, pre-washed terry towelling was agitated in a 1 litre Terg-o-tometer (trade name) pot containing 10° FH. water for 1 minute. The cloth was removed and excess water was squeezed out. 2.8 ml of the treatment composition (examples 1 to 5, 8 to 10 and A to C) was added to the Terg-o-tometer. The cloth was then returned to the Terg-o-tometer and agitated for a further 5 minutes, after wchich time the cloth was removed and line dried overnight.

The treated cloths were assessed by an expert panel of 14 panellists for perfume intensity on dry fabric 24 hours after it had been treated with the compositions.

In examples 8 to 10, pre-washed terry towelling was agitated for 1 minute in a 1 litre Terg-o-tometer pot containing 10° FH. water and a 1% solution of anionic surfactant (sodium dodecylbenzene sulphonate, ex Aldrich) to simulate anionic carryover. The cloth was removed and excess water was squeezed out. 1.8 ml of the treatment composition (examples 8 to 10) was added to the Tergo-tometer. The cloth was then returned to the Terg-o-tometer and agitated for a further 5 minutes, after which time the cloth was removed, spun dried for 30 seconds and line dried overnight.

The treated cloths were assessed by an expert panel of 12 panellists for perfume intensity on dry fabric 24 hours after it had been treated with the compositions.

For all examples, perfume intensity was scored on a comparative numbering system ranging from 0, denoting undetectable, to 5, denoting exceptionally strong perfume aroma. Results were analysed using a general linear means statistical analysis procedure including normalisation against a standard.

The perfume delivery scores are given in tables 3 and 4, below.

TABLE 3
perfume delivery in absence of anionic carryover

| Example | 1 | 2 | 3 | 4 | 5 | A | B | C |
|---|---|---|---|---|---|---|---|---|
| Droplet | 0.64 | 0.62 | 0.61 | 0.72 | 0.83 | 0.77 | 0.77 | 0.77 |
| size range | to 35 | to 18 | to 20 | to 22 | to 31 | to 66 | to 66 | to 70 |
| (microns)¹ | | | | | | | | |
| Perfume | 1.30 | 1.30 | 1.35 | 1.55 | 1.57 | 0.85 | 1.10 | 1.10 |
| Score | | | | | | | | |

¹80% or more by weight of droplets are within this range, based on D[0, 1] readings using a 45 mm lens and D[0, 9] readings using 45 mm and 1000 mm lenses, taken using a Malvern particle size analyser.

TABLE 4
perfume delivery with anionic carryover

| Example | 8 | 9 | 10 |
|---|---|---|---|
| Droplet size | 0.53 to | 0.53 to | 0.53 to |
| range (microns)¹ | 39.01 | 38.90 | 39.57 |
| Perfume Score | 1.24 | 1.48 | 1.54 |

¹see note ‘1’, table 3

In examples 6 and 7 and D to F, 28 g of unperfumed detergent powder (comprising 22 wt % anionic active ingredient) was predissolved in 7 litres of 10° FH. water. 1 Kg of pre-washed terry-towelling was added to the solution and allowed to soak for 10 minutes. The cloths were then squeezed out by hand and rinsed 3 times in 14 litres of water. 52 g of the composition selected from examples 6, 7, D, E or F was pre-dispersed in the final rinse water and the cloths allowed to soak in the water for 10 minutes. The cloths were then removed and line dried overnight.

The treated cloths were assessed for perfume intensity after 24 hours by an expert panel of 8 panellists. The method of measuring perfume intensity was as described above.

The results are given in table 5.

TABLE 5

| Example | 6 | 7 | D | E | F |
|---|---|---|---|---|---|
| Droplet size | 0.66 | 0.59 | 1.3 | 0.73 | 0.78 |
| range (microns)¹ | to 25 | to 23 | to 75 | to 62 | to 66 |
| Perfume Score | 1.20 | 1.25 | 0.72 | 0.85 | 0.92 |

¹see note ‘1’, table 3

The results in tables 3 and 4 show that for compositions comprising emulsions with at least 80% of the droplets having a mean diameter within the range specified by the invention, perfume delivery is significantly better than for compositions comprising emulsions with droplets having mean diameters outside of the range of the invention.

Storage Stability of the Compositions

The compositions of examples 6, 7, D, E and F were stored in sealed containers at 45° C. The viscosity of each composition was measured after 4 weeks using a Haake RV20 rotoviscometer

MV1 cup and bob at a shear rate of 20s at 20° C. in order to ascertain long range storage stability of the composition.

The results are given in table 6, below.

TABLE 6

| Example | 6 | 7 | D | E | F |
|---|---|---|---|---|---|
| Droplet size | 0.66 | 0.59 | 1.3 | 0.73 | 0.78 |
| range (microns)¹ | to 25 | to 23 | to 75 | to 62 | to 66 |
| Viscosity (mPas)² | 236 | 255 | 602 | 230 | 402 |
| Flocs (% by | 5 | 3 | 20 | 8 | 18 |
| weight)³ | | | | | |
| Homogeneity⁴ | 0 | 0 | 1 | 3 | 1 |

¹see note ‘1’, table 3
²Measured after 4 weeks storage at 45° C.
³Measured by sieving through a metal sieve. The flocs are solids over 1 mm in diameter remaining after sieving.
⁴Measured visually by a panel of 10 people with the results being averaged and given on a scale of from 0 to 5 where 0 denotes homogeneous and 5 denotes marked surface cracking of the product.

The results in table 6 demonstrate that the compositions according to the invention provide long term viscosity stability without any loss of homogeneity and with little formation of flocs. By contrast, Examples D and F thickened unacceptably and suffered high levels of flocculation at high temperature and Example E did not remain homogeneous and also produced significantly higher levels of flocs.

1. An aqueous, liquid fabric conditioning composition comprising:
(i) from 2.1 to 7% of a quaternary ammonium cationic softening compound; and
(ii) a perfume having a ClogP of 2 or more; and
(iii) an oily perfume carrier having a ClogP of 3.5 or more;
where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

2. An aqueous, liquid fabric conditioning composition comprising:
(i) a quaternary ammonium cationic softening compound; and
(ii) a perfume having a ClogP of 2 or more; and
(iii) an oily perfume carrier comprising a mineral oil having a ClogP of 3.5 or more;
where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

3. An aqueous, liquid fabric conditioning composition comprising:
(i) a quaternary ammonium cationic softening compound; and
(ii) a perfume having a ClogP of 2 or more; and
(iii) an oily perfume carrier comprising an ester oil having a ClogP of 3.5 or more; and
(iv) a fatty alcohol
where the composition comprises an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.

4. A composition as claimed in any one of claims 1 to 3, wherein the perfume/perfume carrier emulsion droplet is present at a level from 0.5 to 15% by weight, based on the total weight of the composition.

5. A composition as claimed in any one of claims 1 to 4, wherein the weight ratio of the perfume/perfume carrier emulsion droplets to quaternary ammonium fabric softening compound is from 5:1 to 1:25.

6. A composition as claimed in any one of claims 1 to 5, wherein the weight ratio of perfume to oily perfume carrier is from 1:50 to 2:1.

7. A composition as claimed in any one of claims 1 to 6 wherein the quaternary ammonium cationic softening compound is present in an amount from 2.2 to 6% by weight, based on the total weight of the composition.

8. A composition as claimed in any one of claims 1 to 7 wherein 80% or more by weight of the droplets in the emulsion have a mean diameter of from 0.6 to 35 microns, as measured using a Malvern particle size analyser with a 45 mm lens for D[0,1] measurements and both a 45 mm and a 1000 mm lens for D[0,9] measurements.

9. A composition as claimed in any one of claims 1 to 8 wherein the quaternary ammonium cationic softening compound is represented by formula (I): 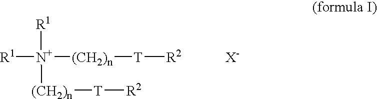
wherein each R¹ group is independently selected from C₁₋₄ alkyl or hydroxyalkyl or C₂₋₄ alkenyl groups; and wherein each R² group is independently selected from C₈₋₂₈ alkyl or alkenyl groups; 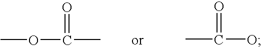
T is
X⁻ is any anion compatible with the cationic surfactant, such as halides or alkyl sulphates, e.g. chloride, methyl sulphate or ethyl sulphate and n is 0 or an integer from 1 to 5.

10. A composition as claimed in any one of claims 1 to 8 wherein the quaternary ammonium cationic softening compound is represented by formula (III): 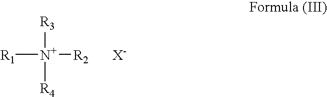
where R₁ and R₂ are C₈₋₂₈ alkyl or alkenyl groups; R₃ and R₄ are C₁₋₄ alkyl or C₂₋₄ alkenyl groups and x⁻ is any anion compatible with the cationic surfactant, such as halides or alkyl sulphates, e.g. chloride, methyl sulphate or ethyl sulphate

11. A method of forming an aqueous, liquid fabric conditioning composition comprising the steps of:
(i) co-melting a quaternary ammonium cationic softening compound and a perfume carrier having a ClogP of 3.5 or more;
(ii) adding the mixture formed in step (i) to water with milling;
(iii) adding perfume having a ClogP of 2 or more to the mixture formed in step (ii);
(iv) subjecting the mixture to further milling.
so as to form a composition comprising an emulsion in which 80% or more by weight of the droplets in the emulsion have a mean diameter of from 0.4 to 60 microns, as measured using a Malvern particle size analyser with a 45 mm lens for D[0,1] measurements and both a 45 mm and a 1000 mm lens for D[0,9] measurements.
